(19) United States
(12) Patent Application Publication
(10) Pub. No.: US 2016/0097107 A1
(43) Pub. Date: Apr. 7, 2016

(54) METHOD FOR PRODUCING MONOSACCHARIDES FROM ALGAE

(71) Applicant: National Chi Nan University, Puli (TW)

(72) Inventors: Yung-Pin TSAI, Puli (TW); Shou-Te CHEN, Sihu Township (TW); Zhi-Yuan HUANG, Puli (TW); Jian-Hao CIOU, Puli (TW); Jhih-Ci YANG, Miaoli City (TW); Meng-Shan LU, Fongshan City (TW); Hao SHIU, Puli (TW)

(21) Appl. No.: 14/628,593

(22) Filed: Feb. 23, 2015

(30) Foreign Application Priority Data
Oct. 3, 2014 (TW) 103134610

(51) Int. Cl. C13K 1/02

(52) U.S. Cl. CPC C13K 1/02

(57) ABSTRACT

A method for producing monosaccharides from algae includes (a) treating algae-containing water using an electrocoagulation device having an iron-based anode to induce flocculation of algae so as to obtain flocculated algae which have a trace amount of iron derived from the iron-based anode, (b) collecting the flocculated algae from the algae-containing water, and (c) subjecting the flocculated algae to an acid hydrolysis reaction in an acid solution to obtain monosaccharides. A liquid-to-solid ratio of a volume of the acid solution to a solid content of the flocculated algae is not less than 12 ml/g. The acid solution has an acid concentration not less than 3% by volume.

### CROSS-REFERENCE TO RELATED APPLICATION

This application claims priority from Taiwanese application no. 103134610, filed on Oct. 3, 2014, the disclosure of which is incorporated in its entirety herein by reference.

### FIELD OF THE INVENTION

This invention relates to a method for producing monosaccharides from algae, more particularly to a method for producing monosaccharides from algae using an electrocoagulation treatment.

### BACKGROUND OF THE INVENTION

Cellulosic biomass materials, such as algae, have complex carbohydrates and may serve as a feedstock for ethanol production. Complex carbohydrates are polysaccharides, and the production of ethanol requires a breakdown of the complex carbohydrates into simple sugars (monosaccharides). A main approach used to breakdown complex carbohydrates is acid hydrolysis.

Electrocoagulation is a process for removing contaminants, such as heavy metal cations or microorganisms (algae), from an effluent by treating the effluent with strong electrical fields. Because the algae collected using an electrocoagulation treatment may have metal ions, in the past, it was undesirable to further treat the metal ion containing algae for producing ethanol.

### SUMMARY OF THE INVENTION

An object of the present invention is to provide a method for producing monosaccharides from algae in a more efficient manner.

Accordingly, a method for producing monosaccharides from algae of the present invention includes the steps of:

(a) treating algae-containing water using an electrocoagulation device having an iron-based anode to induce flocculation of algae so as to obtain flocculated algae which have a trace amount of iron derived from the iron-based anode;

(b) collecting the flocculated algae from the algae-containing water; and

(c) subjecting the flocculated algae to an acid hydrolysis reaction in an acid solution to obtain monosaccharides.

A liquid-to-solid ratio of a volume of the acid solution to a solid content of the flocculated algae is not less than 12 ml/g. The acid solution has an acid concentration not less than 3% by volume.

### BRIEF DESCRIPTION OF THE DRAWINGS

Other features and advantages of the present invention will become apparent in the following detailed description of the embodiments of the invention, with reference to the accompanying drawings, in which:

FIG. 1 is a schematic view of an electrocoagulation device for treating algae-containing water to obtain flocculated algae;

FIG. 2 is a plot illustrating a relation between a yield of monosaccharides and a liquid-to-solid ratio when algae were hydrolyzed using a sulfuric acid solution (3 volume %);

FIG. 3 is a plot illustrating a relation between a yield of monosaccharides and a liquid-to-solid ratio when algae were hydrolyzed using a sulfuric acid solution (6 volume %);

FIG. 4 is a plot illustrating a relation between a yield of monosaccharides and a liquid-to-solid ratio when algae were hydrolyzed using sulfuric acid solutions of different concentrations; and

FIG. 5 is a plot illustrating a relation between a yield of monosaccharides and a liquid-to-solid ratio when the acid hydrolysis of algae was conducted by microwave heating.

### DETAILED DESCRIPTION OF THE EMBODIMENTS

An embodiment of a method for producing monosaccharides from algae according to the present invention includes steps (a) to (c).

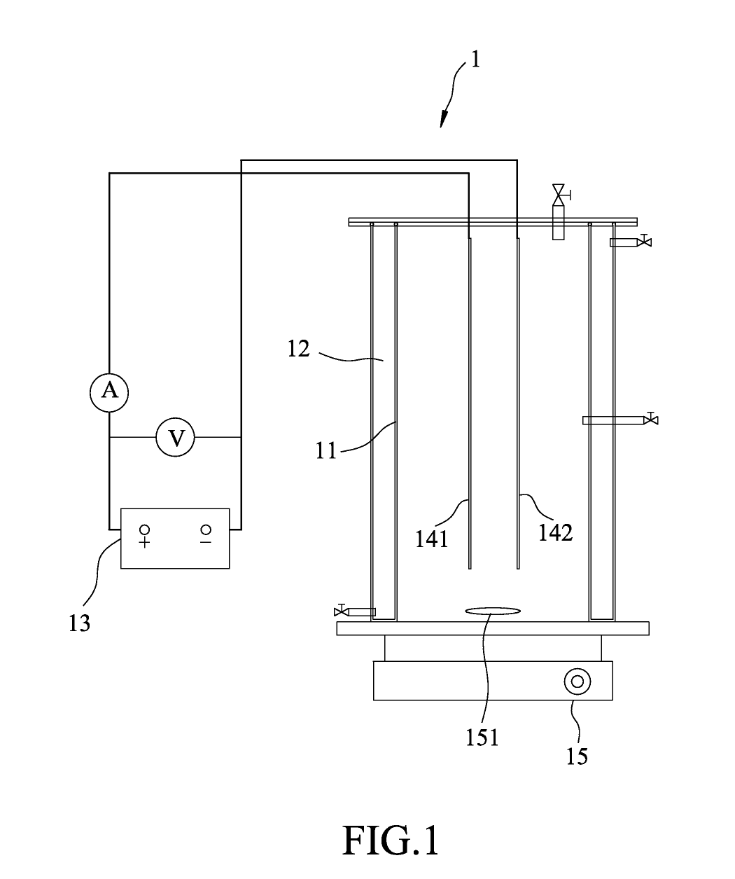

In step (a), algae-containing water is treated using an electrocoagulation device 1 having an iron-based anode 141 (see FIG. 1) to induce flocculation of algae so as to obtain flocculated algae which have a trace amount of iron derived from the iron-based anode 141.

The electrocoagulation device 1 includes a magnetic stirrer 15, an outer tank 12 disposed on the magnetic stirrer 15, an inner tank 11 disposed in the outer tank 12, a power supply 13, the iron-based anode 141, a cathode 142, and a magnet 151 disposed in the inner tank 11. The anode 141 and the cathode 142 are disposed in the inner tank 11 and are respectively connected to positive and negative poles of the power supply 13. In this embodiment, the cathode 142 is made of an iron-based material. The algae-containing water is collected from a eutrophic water body. Before step (a), the algae-containing water is poured into the inner tank 11, and water is poured into the outer tank 12 and is maintained at a constant temperature so as to keep the algae-containing water at the constant temperature. In step (a), the algae-containing water is continuously stirred, and a voltage is applied between the anode 141 and the cathode 142 for electrocoagulation treatment of the algae-containing water so as to induce flocculation of algae. The voltage applied between the anode 141 and the cathode 142 ranges from 4.5 V to 18 V. When the voltage is less than 4.5 V, flocculation of algae may not occur. When the voltage is unduly large, the flocculation of the algae might be destroyed. The treating time for the algae-containing water may range from 30 minutes to 60 minutes.

In step (b), the flocculated algae are collected from the algae-containing water.

In step (c), the flocculated algae are subjected to an acid hydrolysis reaction in an acid solution to obtain monosaccharides, such as glucose, xylose, etc.

In this embodiment, a liquid-to-solid ratio of a volume of the acid solution to a solid content of the flocculated algae is not less than 12 ml/g, and preferably ranges from 20 ml/g to 28 ml/g. The acid solution is a sulfuric acid solution which has an acid concentration not less than 3% by volume, and preferably ranging from 4% to 10% by volume.

In this embodiment, the acid hydrolysis reaction is conducted by heating a mixture of the flocculated algae and the acid solution to a temperature ranging from 50° C. to 150° C., preferably from 80° C. to 150° C. The reaction time for the acid hydrolysis reaction may range from 30 minutes to 60 minutes.

In other embodiments, the acid hydrolysis reaction is conducted by microwave heating the mixture of the flocculated algae and the acid solution.

The present invention will now be explained in more detail below by way of the following experiments.

### Preparation of Algae Powder

### Example 1 (EX 1)

Algae-containing water was collected from Qi-Lin Lake, Lugu, Nantou. For electrocoagulation treatment of the algae-containing water, the electrocoagulation device 1 as illustrated in FIG. 1 was used. The inner tank 11 had an effective volume of 5 liters. Each of the anode 141 and the cathode 142 had a length of 25 cm, a width of 15 cm, and a thickness of 0.1 cm. Each of the anode 141 and the cathode 142 was made of an iron-based material, and a distance between the anode 141 and the cathode 142 was set to 1 cm.

Before treating the algae-containing water, the algae-containing water was poured into the inner tank 11, and distilled water was poured into the outer tank 12 and was maintained at 25° C. The algae-containing water was treated by applying a voltage (9 V) between the anode 141 and the cathode 142 for 60 minutes to induce flocculation of algae. During the application of voltage, the algae-containing water in the inner tank 11 was continuously stirred. Thereafter, flocculated algae were collected from the algae-containing water for further grinding, and an effluent was collected for metal analysis. The flocculated algae were dehydrated and dried at an oven set at 60° C. Next, the flocculated algae were ground into algae powder of about 40 mesh (0.42 mm) or less using a ball mill. The yield of the algae powder was 0.08 g per liter of the algae-containing water. Because iron ions were released from the anode 141 during the treatment, it is assumed that the algae powder contained iron.

### Comparative Example 1 (CE 1)

Algae powder of Comparative Example 1 was prepared in a manner similar to that in Example 1, except that each of the anode 141 and the cathode 142 was made of aluminum, and the algae-containing water was treated for 30 minutes. The yield of the algae powder was 0.074 g per liter of the algae-containing water. Because aluminum ions were released from the anode 141 during the treatment, it is assumed that the algae powder contained aluminum.

### Comparative Example 2 (CE 2)

Algae powder of Comparative Example 2 was prepared in a manner similar to that in Comparative Example 1, except that each of the anode 141 and the cathode 142 was made of stainless steel, and the voltage between the anode 141 and the cathode 142 was set to 30 V. The yield of the algae powder was 0.073 g per liter of the algae-containing water. Because surfaces of the stainless steel anode 141 and cathode 142 are protected by chromium(III) oxide, it is assumed that the metal ions contained in the algae powder is negligible, and that the algae powder of CE 2 is similar to algae conventionally used for producing ethanol.

Metal Analysis

A controlled amount of a sample of algae powder was disposed in a Teflon® vessel, and nitric acid was added into the Teflon vessel. Next, the Teflon vessel was disposed in a microwave digester (CEM Corporation, MD-T886). After the digestion of the algae powder was completed, the product was filtered through a 0.22 micron filter, and then diluted by water to a predetermined concentration, thereby obtaining a diluted solution. A metal (iron/aluminum) analysis was carried out on the diluted solution by inductively coupled plasma optical emission spectrometry (Jobin-Yvon JY2000-2) at a specific wavelength (259.940 nm (iron) or 309.271 nm (aluminum)). The signal intensity at the specific wavelength was compared with a calibration curve of a standard metal sample to calculate the concentration of metal. The algae powder of each of EX 1 and CE 1 was subjected to metal analysis. The effluent of each of EX 1 and CE 1 was also subjected to metal analysis in a manner similar to that for algae powder. The results are shown in Table 1.

TABLE 1

| | | Metal content per | Metal content per |
|---|---|---|---|
| | Analyzed | gram of algae | liter of effluent |
| | object | powder (g/g) | (g/l) |
| EX 1 | Iron | 0.088 | 6.33 × 10⁻⁴ |
| CE 1 | Aluminum | 0.163 | 5.23 × 10⁻⁴ |

From the results shown in Table 1, it can be found that the algae powder of EX 1 is iron containing algae powder and the algae powder of CE 1 is aluminum containing algae powder.

### Experiment 1

### Acid Hydrolysis of Algae Powder Using a Sulfuric Acid Solution (3 Volume %)

Algae powder was fully dried and then subjected to hydrolysis at 120° C. using a sulfuric acid solution at different liquid-to-solid ratios (4 ml/g, 6 ml/g, 8 ml/g, 10 ml/g, 12 ml/g, 14 ml/g, 16 ml/g, 18 ml/g, 20 ml/g, 22 ml/g, 24 ml/g, 26 ml/g, 28 ml/g, 30 ml/g, and 40 ml/g). The sulfuric acid solution was prepared by slowly adding 30 ml of a commercial sulfuric acid (95-97% (w/v)) to 970 ml of deionized water. The sulfuric acid solution had an acid concentration of 3% by volume. After 30 minutes, the test samples that were treated at different liquid-to-solid ratios were filtered to obtain sugar solutions.

Each sugar solution was diluted and evaluated using a reducing sugar test. A reducing sugar is any sugar that has an aldehyde or ketone group. In the reducing sugar test, 3,5-dinitrosalicylic acid (DNS) (yellow) will react with reducing sugars to form 3-amino-5-nitrosalicylic acid (orange red), which absorbs light strongly at 540 nm.

In this experiment, a test agent was prepared by dissolving DNS (1 g), potassium sodium tartrate (30 g), and NaOH (1.6 g) in 100 ml distilled water at a raised temperature. Each of the sugar solutions was evaluated by mixing 3 ml of the sugar solution with 3 ml of the test agent to obtain a mixture, and heating the mixture using a water bath controlled at 100° C. for 10 minutes. The mixture was analyzed spectrophotometrically at 540 nm using a Shimadzu UV-1601 spectrophotometer. The signal intensity at 540 nm was compared with calibration curves of glucose and xylose to calculate the amount of monosaccharides and to calculate the yield of monosaccharides per gram of the algae powder.

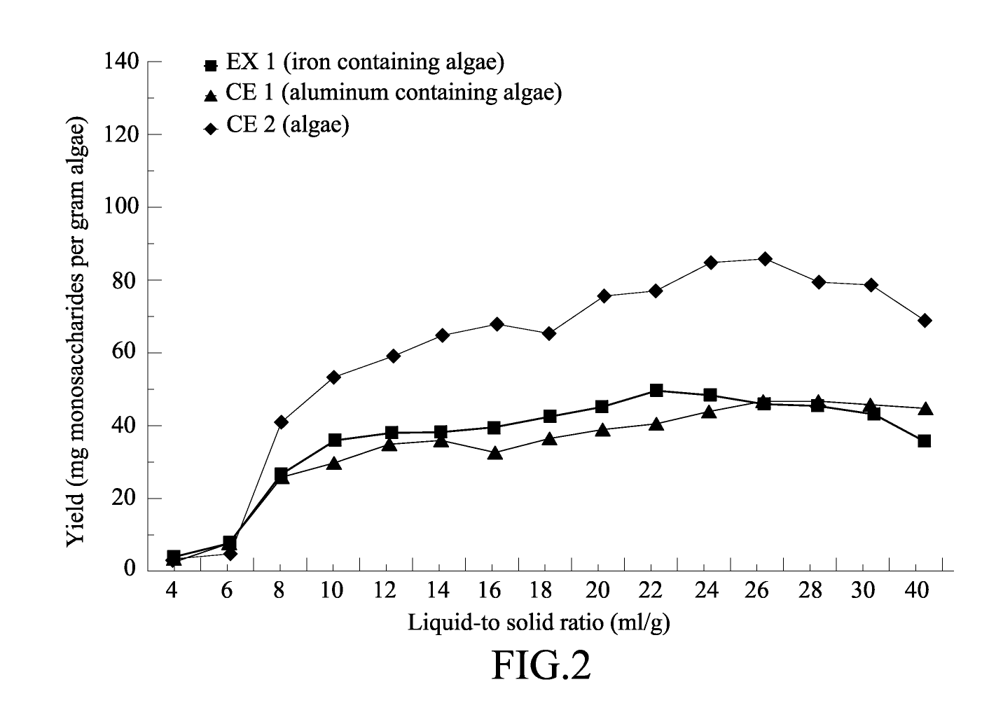

The algae powder of each of EX 1, CE 1, and CE 2 was subjected to the acid hydrolysis for evaluation. The results are shown in FIG. 2.

From the results shown in FIG. 2, it can be found that when the algae powder was hydrolyzed using a sulfuric acid solution of a relatively low acid concentration (3 volume %), the yield of monosaccharides from the iron or aluminum containing algae (EX 1 or CE 1) is less than that from the algae conventionally used for producing ethanol (CE 2).

### Experiment 2

### Acid Hydrolysis of Algae Powder Using a Sulfuric Acid Solution (6 Volume %)

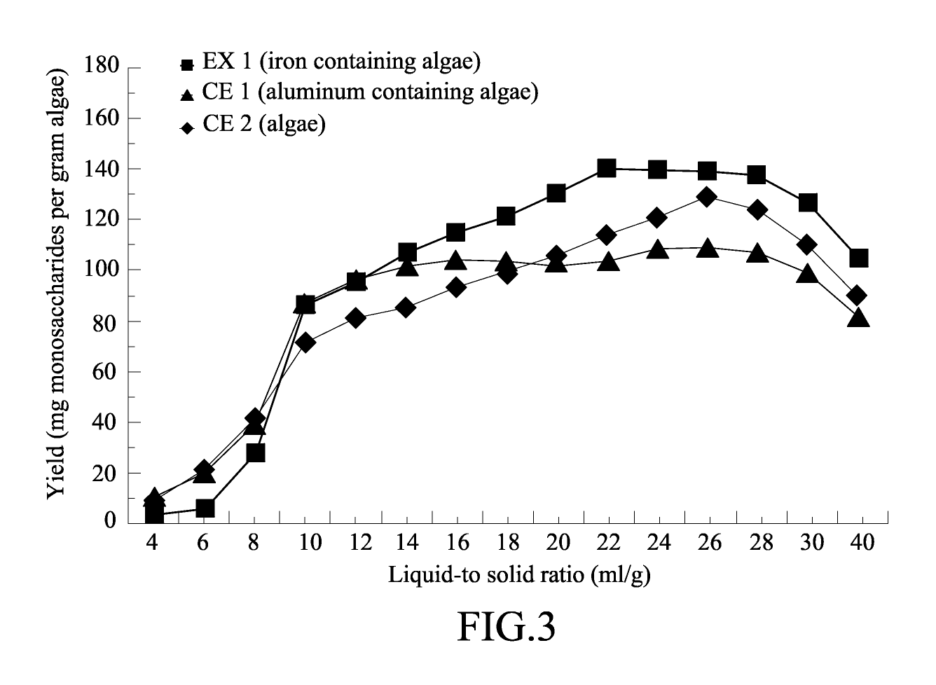

In Experiment 2, the algae powder of each of EX 1, CE 1 and CE 2 was subjected to the acid hydrolysis and evaluated according to the procedures used in Experiment 1, except that the sulfuric acid solution was prepared by slowly adding 60 ml of a commercial sulfuric acid (95-97%(w/v)) to 940 ml of deionized water. The sulfuric acid solution had an acid concentration of 6% by volume. The results are shown in FIG. 3.

From the results shown in FIG. 3, it is surprisingly found that when the liquid-to-solid ratio ranges from 12 ml/g to 40 ml/g, the yield of monosaccharides from the iron containing algae (EX 1) is greater than that from the aluminum containing algae (CE 1) or that from the algae conventionally used for producing ethanol (CE 2). To obtain the highest yield of monosaccharides, the best liquid-to-solid ratio for the algae powder of EX 1 is 22 ml/g, and the best liquid-to-solid ratio for the algae powder of CE 1 or CE 2 is 26 ml/g.

### Experiment 3

### Acid Hydrolysis of Algae Powder Using Sulfuric Acid Solutions of Different Acid Concentrations

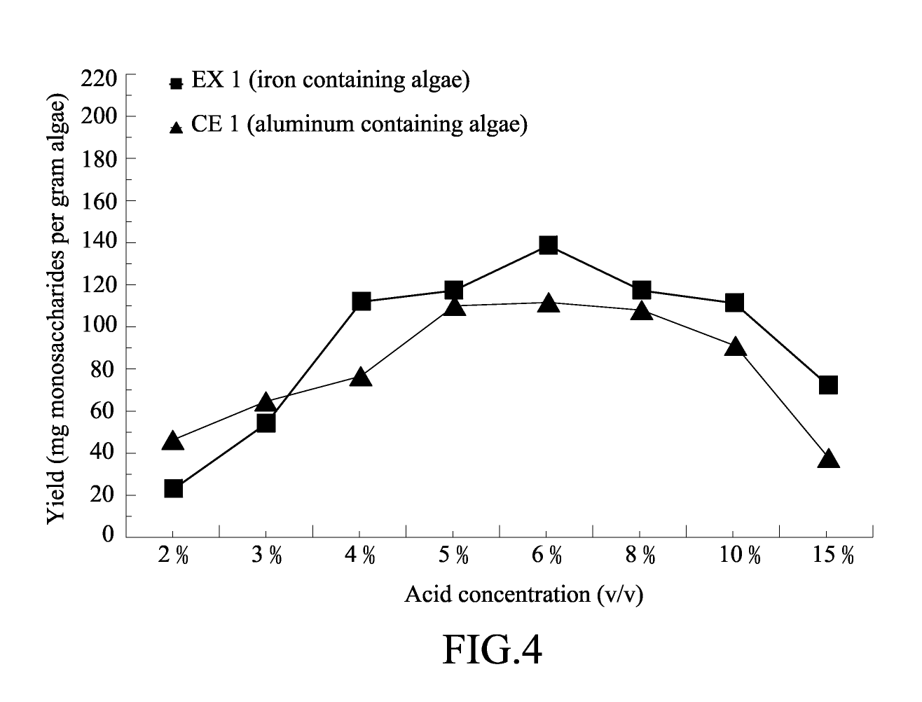

In Experiment 3, the algae powder of each of EX 1 and CE 1 was subjected to acid hydrolysis and evaluated according to the procedures used in Experiment 1, except that the algae powder was subjected to acid hydrolysis at a constant liquid-to-solid ratio using sulfuric acid solutions of different acid concentrations (2 volume %, 3 volume %, 4 volume %, 5 volume %, 6 volume %, 8 volume %, 10 volume %, and 15 volume %). The liquid-to-solid ratio for hydrolyzing the algae powder of EX 1 was 22 ml/g, and the liquid-to-solid ratio for hydrolyzing the algae powder of CE 1 was 26 ml/g. The results are shown in FIG. 4.

From the results shown in FIG. 4, it is found that relatively high yields of monosaccharides can be obtained when the algae powder of EX 1 was treated using a sulfuric acid solution of an acid concentration ranging from 4 volume % to 8 volume %.

### Experiment 4

### Acid Hydrolysis of Algae Powder by Microwave Heating

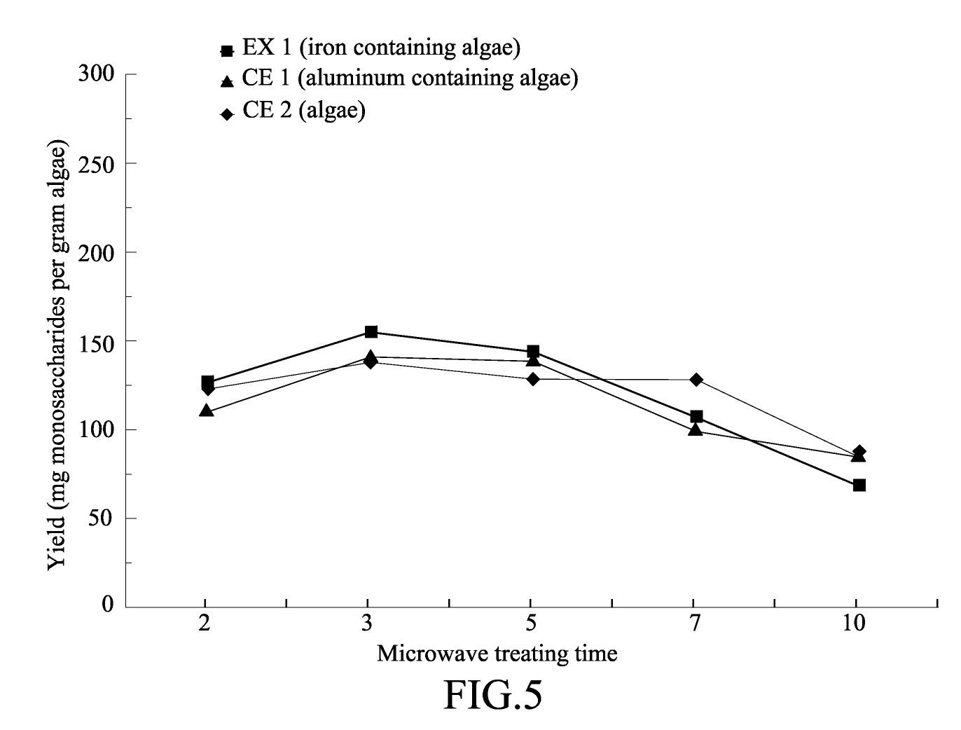

In Experiment 4, the algae powder of each of EX 1, CE 1, and CE 2 was subjected to acid hydrolysis and evaluated according to the procedures used in Experiment 2, except that the algae powder was subjected to acid hydrolysis at a constant liquid-to-solid ratio using a sulfuric acid solution and by microwave heating (1200 watts). The sulfuric acid solution had an acid concentration of 6% by volume. The liquid-to-solid ratio for hydrolyzing the algae powder of EX 1 was 22 ml/g, and the liquid-to-solid ratio for hydrolyzing the algae powder of each of CE 1 and CE 2 was 26 ml/g. The results are shown in FIG. 5.

From the results shown in FIG. 5, it can be found that a better yield of monosaccharides can be obtained when acid hydrolysis of the iron containing algae powder (EX 1) was accelerated by using microwave heating for a time period not greater than 5 minutes.

The results of Experiments 1 to 4 are summarized in Table 2 below. It can be found that when the algae powder was treated with a sulfuric acid solution of a high concentration (6 volume %) without applying microwave energy, the monosaccharide yield from the iron containing algae powder of EX 1 is higher than the monosaccharide yield from the aluminum containing algae powder of CE 1 or from the algae powder of CE 2. When microwave energy was applied for accelerating the acid hydrolysis of the algae powder, the monosaccharide yield can be further improved.

TABLE 2

| | Best L/S | Acid | | | |
|---|---|---|---|---|---|
| | ratio | conc. | | Time | Yield |
| | (ml/g) | (vol %) | Microwave | (min) | (mg/g) |
| EX 1 | 22 | 3 | — | 30 | 50 |
| (Iron | 26 | 6 | — | 30 | 140 |
| containing) | 26 | 6 | 3 min | 3 | 162 |
| CE 1 | 26 | 3 | — | 30 | 43 |
| (Aluminum | 22 | 6 | — | 30 | 108 |
| containing) | 22 | 6 | 3 min | 3 | 136 |
| CE 2 | 26 | 3 | — | 30 | 85 |
| | 26 | 6 | — | 30 | 129 |
| | 26 | 6 | 3 min | 3 | 132 |

* L/S ratio: liquid-to-solid ratio

While the present invention has been described in connection with what is considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for producing monosaccharides from algae, comprising the steps of:
(a) treating algae-containing water using an electrocoagulation device having an iron-based anode to induce flocculation of algae so as to obtain flocculated algae which have a trace amount of iron derived from the iron-based anode;
(b) collecting the flocculated algae from the algae-containing water; and
(c) subjecting the flocculated algae to an acid hydrolysis reaction in an acid solution to obtain monosaccharides;
wherein:
a liquid-to-solid ratio of a volume of the acid solution to a solid content of the flocculated algae is not less than 12 ml/g; and
the acid solution has an acid concentration not less than 3% by volume.

2. The method according to claim 1, wherein the algae-containing water is collected from a eutrophic water body.

3. The method according to claim 1, wherein, in step (c), the acid hydrolysis reaction is conducted by microwave heating a mixture of the flocculated algae and the acid solution.

4. The method according to claim 1, wherein the acid solution is a sulfuric acid solution.

5. The method according to claim 4, wherein the acid concentration ranges from 4% to 10% by volume.

6. The method according to claim 5, wherein the liquid-to-solid ratio ranges from 20 ml/g to 28 ml/g.
